(19) United States
(12) Patent Application Publication
(10) Pub. No.: US 2003/0224529 A1
(43) Pub. Date: Dec. 4, 2003

(54) Dual ion source assembly

(76) Inventors: Romaine Maiefski, Oceanside, CA (US); Jonathan Krakover, Charlottesville, VA (US)

Correspondence Address: PERKINS COIE LLP, PATENT-SEA, P.O. BOX 1247, SEATTLE, WA, 98111-1247, US

(21) Appl. No.: 10/160,584

(22) Filed: May 31, 2002

(51) Int. Cl. G01N 24/00

(52) U.S. Cl. 436/173; 436/174; 436/177; 436/181; 250/282; 250/288; 422/83; 422/93

(57) ABSTRACT

Apparatuses and methods for producing ions from chemical species analyzing chemical species. In one embodiment, an apparatus includes a first ion source assembly that produces a first sample flow and a second ion source assembly that produces a second sample flow. The first and second ion source assemblies operate substantially at atmospheric pressure, and the second ion source assembly is different from the first ion source assembly. The apparatus also includes a separation member positioned at least partially between the first and second ion source assemblies, the separation member being shaped and sized to reduce interference between the first sample flow and the second ion source assembly and between the second sample flow and the first ion source assembly. In one embodiment, the first ion source assembly can include an electrospray ion source assembly and the second ion source assembly can include an atmospheric pressure chemical ionization source assembly.

### TECHNICAL FIELD

The present invention relates to multiple ion source assemblies. More specifically, the present invention is directed to multiple ion source assemblies in which at least two different ion sources operate simultaneously.

### BACKGROUND

High throughput purification systems often use mass analyzers to determine if a target compound is within a selected sample portion. One such system is disclosed in U.S. Pat. No. 6,309,541 to Maiefski et al., which is hereby incorporated by reference. Mass analyzers, such as mass spectrometers, work by using magnetic and/or electrical fields to exert forces on charged particles (ions). Accordingly, a compound must be charged or ionized in order to be examined by a mass analyzer. Moreover, in many applications, ions must be in a gaseous phase before they can be introduced into the mass analyzer. Atmospheric pressure ionization sources, including electrospray ionization (ESI) and atmospheric pressure chemical ionization (“APCI”) sources, can be interfaced with mass analyzers to examine samples. In atmospheric pressure ionization methods, a combination of thermal and pneumatic means is used to desolvate the ions in the ionization source. For example, ESI includes spraying a sample solution across a high potential difference (a few kilovolts) from a needle into an orifice. Heat and gas flows are used desolvate the ions existing in the sample solution. APCI is similar to ESI; however, it utilizes a corona discharge needle to ionize the sample in the atmospheric pressure region.

Each of the APCI and ESI sources are typically optimized for certain selected chemical classes or functionalities. APCI sources are typically known to work better than ESI sources for ionizing non-polar compounds, and ESI sources are typically known to work better than APCI sources for ionizing polar compounds. Often times a sample flow may contain mulitple chemical species including both polar and non-polar compounds. Accordingly, it is advantageous to have multiple ionizing sources to maximize the number of chemical species that will be ionized for analysis. U.S. Pat. No. 6,207,954 to Andrien, Jr., et al. (“'954 patent”), which is hereby incorporated by reference, discloses ESI and APCI sources with multiple sample introduction means interfaced with mass analyzers. The '954 patent further discloses a configuration with ESI and APCI sources in a single atmospheric pressure ionization assembly. Such a configuration, however, can experience significant difficulties if both ion sources operate simultaneously because interference between the two sources can hamper proper operation of the system. For example, the voltage applied to the ESI probe tip can interfere with the electrical field in the corona discharge region, and similarly, the voltage applied to the corona discharge needle can interfere with the ESI process.

### SUMMARY

The present invention is directed to apparatuses for producing ions from chemical species, apparatuses for analyzing chemical species, and methods for analyzing chemical species. In one embodiment, an apparatus for producing ions from chemical species includes a first ion source assembly that produces a first sample flow, and a second ion source assembly that produces a second sample flow. The first and second ion source assemblies operate substantially at atmospheric pressure, and the second ion source assembly is different from the first ion source. The apparatus also includes a separation member that reduces interference between the first sample flow and the second ion source assembly and between the second sample flow and the first ion source assembly. In one embodiment, the first ion source assembly can include an electrospray ion source, and the second ion source assembly can include an atmospheric pressure chemical ionization source.

An embodiment for analyzing chemical species includes a first ion source assembly that produces a first sample flow and a second ion source assembly that produces a second sample flow. The first and second ion source assemblies operate substantially at atmospheric pressure, and the second ion source assembly is different from the first ion source assembly. The apparatus also includes a separation member that temporarily separates the first sample flow from the second sample flow and reduces interference between the first ion source assembly and the second sample flow and between the second ion source assembly and the first sample flow. The apparatus can also include a mass analyzer configured to receive the first sample flow and the second sample flow.

In another embodiment, an apparatus for analyzing chemical species includes providing a first ion source assembly, a second ion source assembly different from the first ion source, a separation member, and a mass analyzer. Simultaneously producing a first plurality of ions in a first sample flow from the first ion source assembly and a second plurality of ions in a second sample flow from the second ion source assembly. The method further includes reducing interference between the first ion source assembly and the second sample flow and between the second ion source assembly and the first sample flow with the separation member.

Another embodiment for analyzing chemical species includes providing a first ion source assembly, a second ion source assembly different from the first ion source assembly, a separation member, and a mass analyzer. Simultaneously producing a first plurality of ions in a first sample flow from the first ion source assembly and a second plurality of ions in a second sample flow from the second ion source assembly. The method further includes temporarily separating the first sample flow and the second sample flow with the separation member.

An embodiment for manufacturing an apparatus for analyzing chemical species includes positioning an electrospray ion source and an atmospheric pressure chemical ionization source proximate to a mass analyzer. The method further includes placing a separation member that extends at least partially between the electrospray ion source assembly and the atmospheric pressure chemical ionization source assembly. The separation member is configured to temporarily separate a first flow from the electrospray ion source assembly and a second flow from the atmospheric pressure chemical ionization source assembly before the first and second flows enter the mass analyzer.

### BRIEF DESCRIPTION OF THE DRAWINGS

FIG. 1 is a front isometric view of a dual ion source assembly having first and second ion sources coupled to a mass analyzer.

FIG. 2 is an enlarged isometric view of the dual ion source assembly of FIG. 1.

FIG. 3 is an enlarged isometric view of an ESI source assembly of FIG. 2 shown removed from the mounting plate.

FIG. 4 is an enlarged isometric view of an APCI source assembly of FIG. 2 shown removed from the mounting plate.

FIG. 5 is an isometric view of a dual ion source assembly in accordance with an alternate embodiment having a multi-component separator assembly.

### DETAILED DESCRIPTION

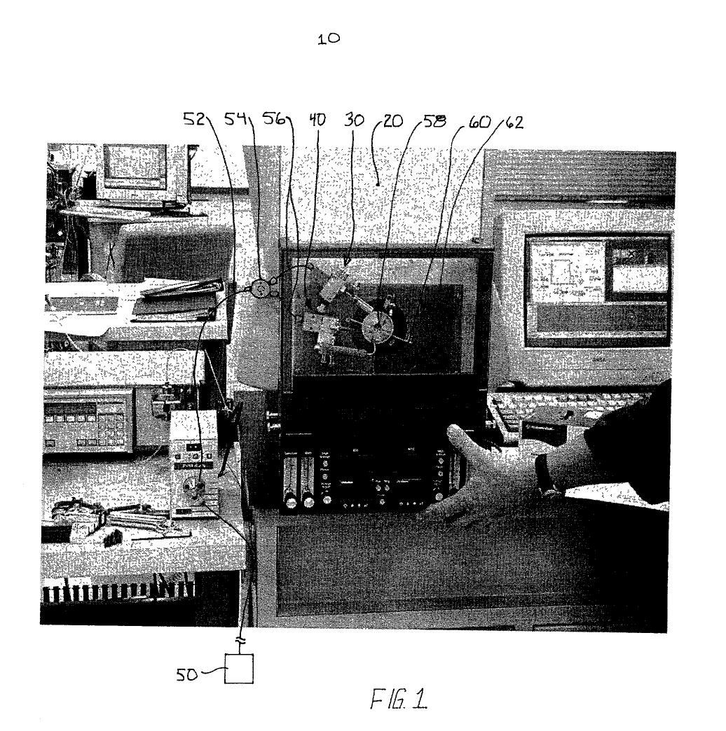

In the following description, certain specific details are set forth in order to provide a thorough understanding of embodiments of the invention. The present disclosure describes dual ion source assemblies couplable to mass analyzers in accordance with embodiments of the present invention. Many specific details of certain embodiments are set forth in the following description and in FIGS. 1-4 to provide a thorough understanding of these embodiments. One skilled in the relevant art will understand, however, that the present invention may have additional embodiments, and that the invention may be practiced without several of the details described below. For example, even though the embodiments of the dual ion source assemblies are described with reference to electrospray and atmospheric pressure chemical ionization sources, other ionization methods may be used. Moreover, well known devices associated with ion source assemblies, such as mass spectrometers, have not been shown or described in detail to avoid unnecessarily obscuring the description of the embodiments of the invention.

FIG. 1 is a front isometric view of a dual ion source assembly 10 having a first ion source assembly and a second ion source assembly coupled to a mass spectrometer 20, or other mass analyzer. Samples to be analyzed are passed as a solution through the dual ion source assembly 10 in which the solution vaporizes and emerges as a spray or mist of droplets. As the droplets evaporate, residual sample ions are swept into a mass analyzer for analysis. In the illustrated embodiment, the first ion source assembly is an APCI source assembly 30, and the second ion source assembly is an ESI source assembly 40. The APCI source assembly 30 and the ESI source assembly 40 are connected to a fluid system, such as a sample purification system that receives selected samples from at least one sample source 50. In the illustrated embodiment, the APCI source assembly 30 and the ESI source assembly 40 are both coupled to a sample flow line 52 that receives a selected flow of fluid carrying samples from the sample source 50. In other embodiments, the APCI and ESI source assemblies 30 and 40 can be coupled to multiple sample sources and/or separate sample sources.

In the illustrated embodiment, the sample flow line 52 is connected to a splitter 54 that divides the flow of samples into two separate flows. These two separate flows are delivered by sample delivery lines 56 to the APCI and ESI source assemblies 30 and 40 for ionization. The APCI and ESI source assemblies 30 and 40 deliver the ionized sample flows substantially simultaneously to an inlet 58 of the mass spectrometer 20, for analysis. A separation member 60 is positioned adjacent to the mass spectrometer's inlet 58 and at least partially between the APCI and ESI source assemblies 30 and 40. The separation member 60, as discussed in greater detail below, helps separate and isolate the two flows of ions from each other before they enter the mass spectrometer 20. The separation member 60 also minimizes any cross interference that the APCI or ESI source assembly 30 or 40 may have on the flow of ions from the other source assembly, thereby maximizing the amount of the ionized sample entering the mass spectrometer 20 for analysis.

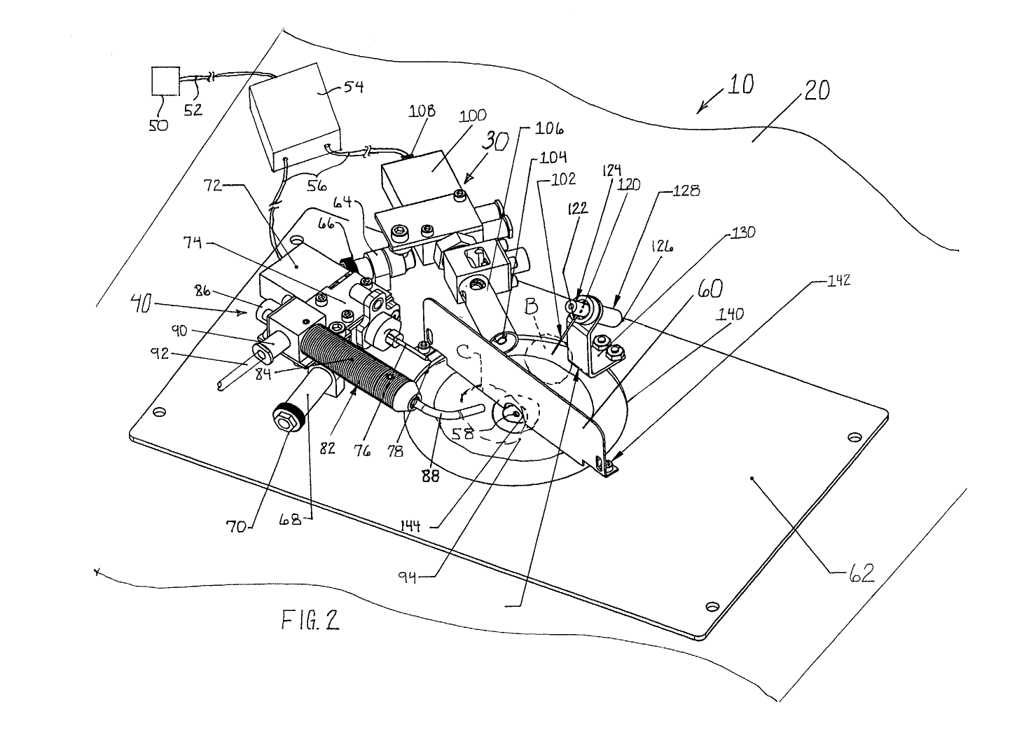

FIG. 2 is an enlarged isometric view of the dual ion source assembly 10 coupled to the mass spectrometer 20. The APCI and ESI source assemblies 30 and 40 are shown mounted on the mass spectrometer 20 in a generally side-by-side arrangement, but on opposite sides of the separation member 60. The APCI and ESI source assemblies 30 and 40 can be positioned to optimize the production of ions proximate to the inlet 58 leading into the mass spectrometer 20. In the illustrated embodiment, the APCI and ESI source assemblies 30 and 40 are moveably connected to a mounting plate 62, which is releasably mounted to the front of the mass spectrometer 20.

An adjustable mount 64 connects the APCI source assembly 30 to the mounting plate 62. The mount 64 includes an adjustment member 66 that enables the user to selectively aim the APCI source assembly 30 toward the inlet 58 of the mass spectrometer exposed on one side of the separation member 60. Similarly, an adjustable mount 68 connects the ESI source assembly 40 to the mounting plate 62. The mount 68 also includes an adjustment member 70 that enables a user to aim the ESI source assembly 40 toward the inlet 58 of the mass spectrometer exposed on the other side of the separation member 60. Once the APCI source assembly 30 or the ESI source assembly 40 has been properly aimed, the respective adjustment member 66 or 70 can be tightened to securely hold the APCI or ESI source assembly 30 or 40 in place. In one embodiment, locking mechanisms can be used to prevent inadvertent movement of the APCI or ESI source assembly 30 or 40 after it has been aimed at the mass spectrometer's inlet 58. The ability to position the APCI and ESI source assemblies 30 and 40 allows for optimization of the simultaneous delivery of the ionized sample flows to the mass spectrometer 20 over a wide range of liquid flow rates, solutions, and sample chemistries.

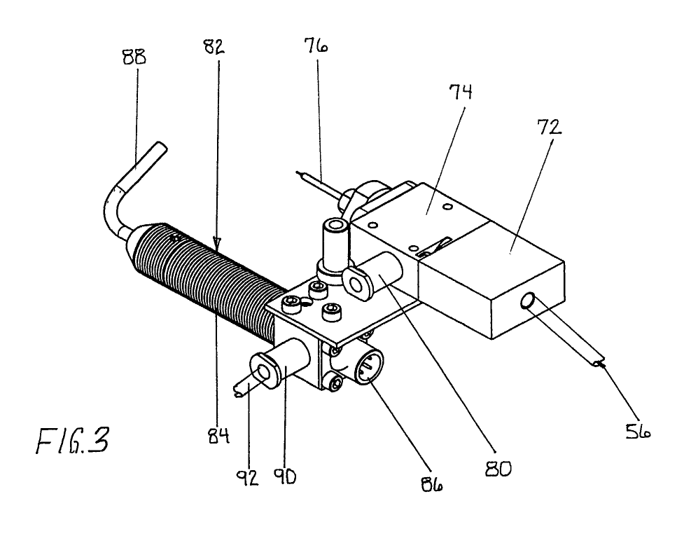

FIG. 3 is an enlarged isometric view of 30the ESI source assembly 40 shown removed from the mounting plate 62 and aimed toward locations on opposite sides of the separation member 60. Referring to FIGS. 2 and 3, the ESI source assembly 40 uses an electric field to produce a fine spray of sample flow, including charged droplets that may be passed to the mass spectrometer 20 (FIG. 2). The ESI source assembly 40 includes a regulator assembly 72 attached to a nebulizer assembly 74. The regulator assembly 72 regulates the sample flow rate and pressure after the sample solution is received from the sample delivery line 56. The nebulizer assembly 74 includes an elongated tube 76 with a distal tip 78 aimed toward the inlet 58 of the mass spectrometer 20. The nebulizer assembly 74 may also include a pneumatic nebulization assist. A gas line may be coupled to an inlet port 80 to supply the gas used in the pneumatic nebulization assist.

The ESI source assembly 40 of the illustrated embodiment also includes a heater assembly 82 that generates a flow of heated gas, such as nitrogen, to facilitate evaporation of the nebulized sample flow. The heater assembly 82 can include a heating element disposed within a gas tube 84 and removably connect to a power source via an integral connector 86 . In one embodiment, the heating element can include a coil that heats the gas as it passes through the gas tube 84. A nozzle 88 can be attached to the distal end of the gas tube 84 to direct the flow of the heated gas toward the flow of ions as they approach the mass spectrometer's inlet 58. The flow of heated gas helps direct the ions into the mass spectrometer's inlet 58. The gas can be supplied through a gas line 90 coupled to an inlet 92 in the heater assembly 82. In additional embodiments, the ESI source assembly 40 can use other techniques, as needed, to assist in providing the flow of ions into the mass analyzer.

In one embodiment, mass spectrometer 20 (FIG. 2) has a metal or other electrically conductive material that forms an end plate 94 that includes the inlet 58. The end plate 94 has a voltage potential of approximately 0-200 Volts. The tube 76 of the ESI source assembly 40 is charged at approximately 700 Volts. To produce positive ions, a negative potential is applied to the tube 76. To produce negative ions, the polarity of the potential applied to the tube 76 is reversed. The separation member 60 is maintained at ground potential and is not in direct engagement with the end plate 94.

In operation, the sample solution flows from the sample source 50 (FIG. 1) along the sample flow line 52 to the splitter 54, wherein a portion of the sample flow is directed to the ESI source assembly 40 and the other portion is directed to the APCI source assembly 30. The splitter 54 can selectively control how the flow is divided between the APCI and ESI source assemblies 30 and 40. The flow of sample solution enters the ESI source assembly 40 through a sample inlet port 96 (FIG. 2) and the pressure and sample flow rate are regulated by the regulator assembly 72. The sample solution then flows through the nebulizer assembly 74 and out of the tube's tip 78 as a fine spray. The sample can be sprayed from the tip 78 at flow rates ranging from below 2 ml/min to above 0.01 ml/min. When the appropriate potentials are applied to the tube 76 and the tip 78, charged liquid droplets are produced from the ESI source assembly 40. The charged droplets exit the tip 78 and are driven by the electric field through the heated gas flow. As the droplets pass through the heated gas flow, they evaporate and rapidly become much smaller through vaporization of solvent that makes up portions of the droplets. At the same time, because the surface area of the droplets gets smaller and smaller, the density of electrical charge on the surface increases until a point of instability is reached. Eventually, not only solvent molecules but also ions start to desorb from the surface of each droplet, thereby providing the flow of charged ions. The flow of ions is swept into the inlet 58 and directed into the mass spectrometer for analysis.

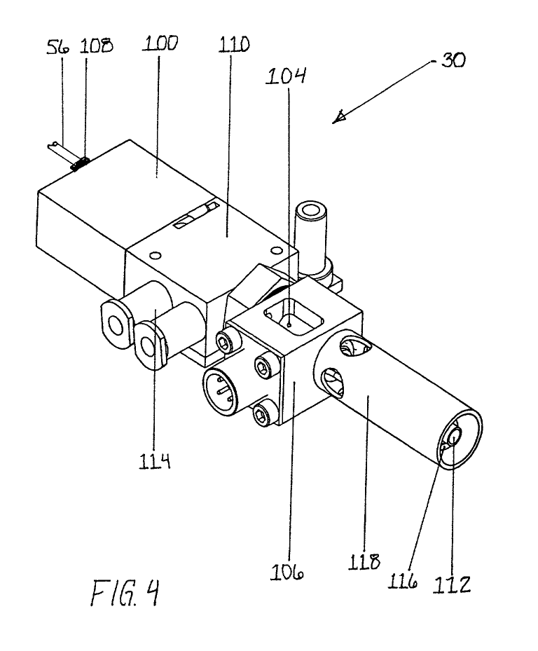

While the ESI source assembly 40 is generating the flow of ions, the APCI source assembly 30 is simultaneously generating its flow of ions on the opposite side of the separation member 60. FIG. 4 is an enlarged isometric view of an APCI source assembly of FIG. 2 shown removed from the mounting plate. Referring to FIGS. 2 and 4, the APCI source assembly 30 can include a regulator assembly 100, a corona needle 102 (FIG. 2), an injector assembly 104, and a heater assembly 106. In the illustrated embodiment, the regulator assembly 100 is similar to the regulator assembly 72 discussed above. The regulator assembly 100 receives the flow of sample solution through a sample inlet port 108 (FIG. 2) and regulates the flow rate and pressure of the solution. In an alternate embodiment, the flow rates and pressure of the solution is sufficiently stable, so that the regulator assembly 100 is not needed. In the illustrated embodiment, the injector assembly 104, including a housing 110 and a nebulizer tube 112, is attached to the regulator assembly 100. The injector assembly 104 can also include a pneumatic nebulization assist, wherein a selected gas is supplied through gas lines (not shown) coupled to inlet ports 114.

The nebulizer tube 112 produces sprayed liquid droplets that flow into the heater assembly 106. In one embodiment, the heater assembly 106 includes a chamber surrounded by a heating element 116, such as a coil. Within the heater assembly 106, the nebulized liquid droplets evaporate, forming a vapor prior to exiting from a heat shield 118. The flow of vapor containing the ions is directed toward the inlet 58 in the mass spectrometer 20, such that the flow of vapor enters a region B surrounding the corona needle 102 (FIG. 2) and adjacent to the separation member 60.

In operation, the corona needle 102 is connected to a high voltage source so as to generate an electrical field proximate to the APCI source assembly 30. In one embodiment, the corona needle 102 (FIG. 2) can be maintained with an electrical potential of approximately 2600-3200 Volts. The resulting electrical field acts on the gas flow through the heater assembly 106 to establish a stable corona discharge in region B around the corona needle 102 to produce the flow of charged ions. The ions produced in region B by the atmospheric pressure chemical ionization are driven by the electric field toward the inlet 58, such that the ions are swept into the mass spectrometer 20 through the inlet to be analyzed. The separation member 60 separates the flow of vapor and resulting ions from the APCI source assembly 30 from the flow of vapor and ions produced by the ESI source assembly 40. The separation member 60 also minimizes the effect that the APCI and the ESI source assemblies 30 and 40 have on each other's flow of ions toward the inlet 58. In the illustrated embodiment, the corona needle 102 is physically secured and electrically connected to an electrical connector 120. One end 122 of the corona needle 102 is threaded through an aperture in a first end 124 of the electrical connector 120. The electrical connector 120 includes a second end 126 configured to be connected to an external voltage source. The electrical connector 120 is electrically connected to the corona needle 102 to provide the corona needle 102 with the necessary voltage. An insulator 128, such as a banana jack, surrounds a portion of the electrical connector 120 between the first and second ends 124 and 126. The insulator 128 is attached to the mounting plate 62 by a mounting bracket 130. In the illustrated embodiment, the corona needle 102 is moveable so that it may be properly oriented to create the electric field. For example, the corona needle 102 can be rotated in a direction R by pivoting the insulator 128, and the corona needle 102 can be moved axially D by sliding the corona needle 102 through the aperture in the electrical connector 120. Accordingly, the electrical field can be precisely positioned and the flow of vapor from the nebulizer tube 112 can be precisely aimed so as to maximize the number of ions swept into the mass spectrometer 20.

As best seen in FIGS. 1 and 2, the separation member 60 is a generally flat plate that extends across an aperture 140 in the mounting plate 62 and is attached to the mounting plate 62 by fasteners 142. The aperture 140 is concentrically arranged around the mass spectrometer's inlet 58, so that the separation member 60 extends directly in front of the inlet 58 so as to separate region B (FIG. 3) from region C (FIG. 3) when the two different ion source assemblies are used simultaneously. The separation member 60 of the illustrated embodiment forms a plane generally transverse to the mounting plate 62 and is positioned such that a center axis A extending from the inlet 58 passes through and approximately bisects the separation member 60. In other embodiments, the separation member can have a different shape, size, orientation, or electrical potential.

In the illustrated embodiment, the separation member 60 includes a cutout section 144 proximate to the inlet 58. The cutout section 144 is shaped and sized to provide the flows of ions sufficient access into the mass spectrometer 20 through the inlet 58, while still allowing the separation member 60 to separate and isolate regions B and C from each other to minimize interference therebetween. In one embodiment, the cutout section 144 is a semicircular void in the separation member 60 positioned proximate to the inlet 58. In other embodiments, other cutout shapes and sizes can be used. In additional embodiments, the separation member 60 may not have a cutout section while being able to isolate regions B and C and also maximizing the results from the simultaneous operation of the APCI source assembly 30 and the ESI source assembly 40 for delivery of ions to the mass spectrometer 20 for analysis.

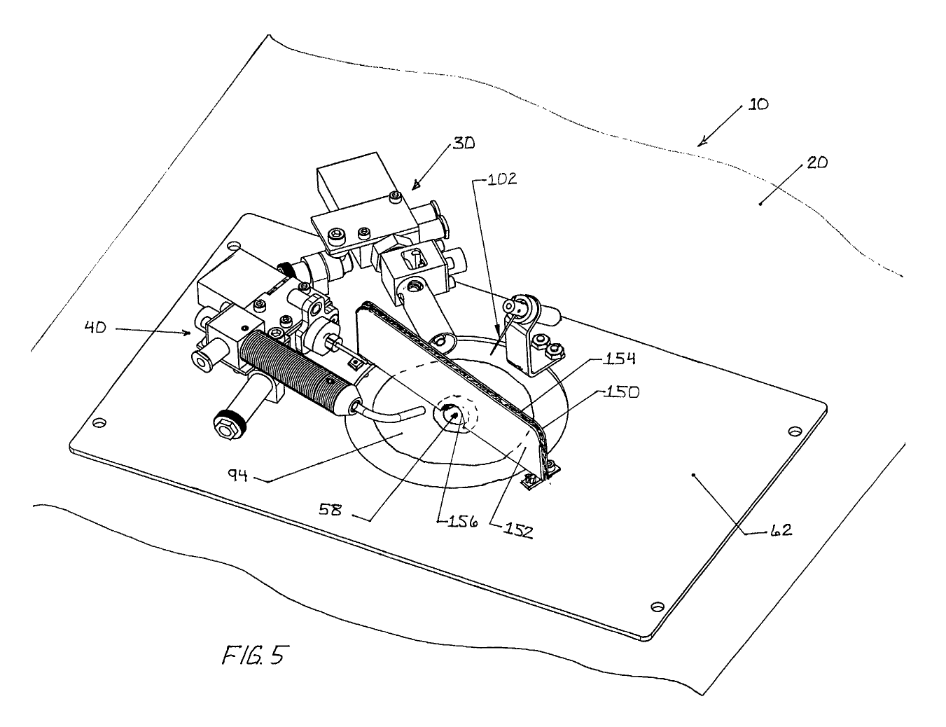

FIG. 5 is an isometric view of a dual ion source assembly 10 in accordance with an alternate embodiment. The APCI source assembly 30 and the ESI source assembly 40 are mounted to the mounting plate 62 adjacent to the mass spectrometer 20 with the separator member 60 between at least portions of the assemblies, as discussed above. In the illustrated embodiment, the separation member 60 is a multi-component assembly with an APCI shield 150 and a separate ESI shield 152. The APCI shield 150 is mounted to the mounting plate 62 out of engagement with the mass spectrometer's end plate 94 and positioned to generally face a portion of the APCI source assembly 30. The APCI shield 150 extends generally adjacent to the inlet 58 of the mass spectrometer 20 while allowing the flow of ions from the APCI source assembly 30 to enter the inlet. The APCI shield 150 can be constructed of an electrically conductive material and maintained at a selected electrical potential to facilitate the flow of ions from the APCI source assembly 30 into the mass spectrometer's inlet 58.

The ESI shield 152 is also mounted to the mounting plate 62 and positioned to face at least a portion of the ESI source assembly 40. The ESI shield 152 is adjacent to the APCI shield 150 but is not in direct contact with the APCI shield. The ESI shield 152 can also be constructed of an electrically conductive material and maintained at a selected electrical potential to facilitate the flow of ions from the ESI source assembly 40 into the inlet 58. The electrical potential of the ESI shield 152 can be the same or different than the electrical potential of the APCI shield 150. In one embodiment, the ESI shield 152 and the APCI shield 150 are spaced apart and electrically isolated from each other. A layer of electrically insulative material 154 can be sandwiched between the ESI shield 152 and the APCI shield 150. In another embodiment, the ESI shield 152 and the APCI shield 150 can be spaced apart from each other by a small air gap.

In the illustrated embodiment, the APCI shield 150 and the ESI shield 152 each have a cutout section 156 proximate to the mass spectrometer's inlet 58. The cutout sections 156 can be the same size or can be different sizes as is suitable for the flow of ions from the respective APCI and ESI source assemblies 30 and 40. The layer of electrically insulative material 154 can also have the same size cutout section 156 or a different size cutout section than is provided in the APCI or ESI shields 150 or 152. Accordingly, the separation member 60 can configured for the selected ion source assemblies mounted on the mass spectrometer to facilitate the efficient simultaneous delivery of two flows of ions to the mass spectrometer for analysis.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An apparatus for producing ions from chemical species for analysis by an analyzer having an inlet, comprising:
a first ion source assembly configured to be positioned adjacent to the analyzer, the first ion source assembly producing a first sample flow directed toward the inlet of the analyzer;
a second ion source assembly configured to be positioned adjacent to the analyzer, the second ion source assembly producing a second sample flow directed toward the inlet of the analyzer, wherein the second ion source assembly is different from the first ion source assembly; and
a separation member positioned at least partially between portions of the first and second ion source assemblies and configured to be positioned adjacent to the inlet of the analyzer, the separation member being shaped and sized to reduce interference between the first sample flow and the second ion source assembly and between the second sample flow and the first ion source assembly.

2. The apparatus of claim 1 wherein the first ion source assembly the second ion source assembly, and the separation member are mounted on a mounting plate, and the mounting plate is configured to be removably attachable to the analyzer.

3. The apparatus of claim 1 wherein the separation member includes a metal plate.

4. The apparatus of claim 1 wherein the separation member includes a plate having a cutout portion positionable adjacent to the inlet.

5. The apparatus of claim 1 wherein the first ion source assembly includes an electrospray ion source assembly.

6. The apparatus of claim 1 wherein the second ion source assembly includes an atmospheric pressure chemical ionization source assembly.

7. The apparatus of claim 1, further comprising:
a primary sample flow line that carries a flow of the chemical species;
a flow splitter connected to the primary sample flow line, a first sample flow line interconnecting the flow splitter to the first ion source assembly; and
a second sample flow line interconnecting the flow splitter to the second ion source assembly.

8. The apparatus of claim 1 wherein the separation member is maintained at a selected electrical potential.

9. The apparatus of claim 1 wherein the separation member includes first and second separator shields spaced apart from each other.

10. The apparatus of claim 9 wherein the first and second separator shields are maintained at different electrical potentials relative to each other.

11. The apparatus of claim 9 wherein the separation member includes a layer of electrically insulative material between the first and second separator shields.

12. An apparatus for producing ions from chemical species, comprising:
a first ion source assembly that produces a first sample flow;
a second ion source assembly that produces a second sample flow,
wherein the second ion source assembly is different from the first ion source assembly; and
a separation member that reduces interference between the first sample flow and the second ion source assembly and between the second sample flow and the first ion source assembly.

13. An apparatus for analyzing chemical species, comprising:
a first ion source assembly that produces a first sample flow;
a second ion source assembly that produces a second sample flow,
wherein the second ion source assembly is different from the first ion source assembly;
a mass analyzer having an inlet configured to receive the first sample flow and the second sample flow; and
a separation member positioned adjacent to the inlet of the mass analyzer, the separation member being shaped and sized to temporarily separate the first sample flow from the second sample flow prior to entering the inlet and to reduce interference between the first ion source assembly and the second sample flow and between the second ion source assembly and the first sample flow.

14. The apparatus of claim 13 wherein the separation member includes a metal plate.

15. The apparatus of claim 13 wherein the separation member has a cutout portion adjacent to the inlet.

16. The apparatus of claim 13 wherein the first ion source assembly includes an electrospray ion source assembly.

17. The apparatus of claim 13 wherein the second ion source assembly includes an atmospheric pressure chemical ionization source assembly.

18. The apparatus of claim 13, further comprising a mounting plate removably attached to the mass analyzer, the first and second ion source assemblies being adjustably mounted on the mounting plate, and the separation member being mounted on the mounting plate at least partially between the first and second ion source assemblies.

19. The apparatus of claim 13 wherein the mass analyzer is a mass spectrometer.

20. The apparatus of claim 13 wherein the separation member extends at least partially between the first ion source assembly and the second ion source assembly.

21. The apparatus of claim 13 wherein the separation member is maintained at a selected electrical potential.

22. The apparatus of claim 13 wherein the separation member includes first and second separator shields spaced apart from each other.

23. The apparatus of claim 22 wherein the first and second separator shields are maintained at different electrical potentials relative to each other.

24. The apparatus of claim 22 wherein the separation member includes a layer of electrically insulative material between the first and second separator shields.

25. An apparatus for analyzing chemical species, comprising:
an electrospray ion source assembly that produces a first sample flow;
an atmospheric pressure chemical ionization source assembly that produces a second sample flow simultaneous with the first sample flow; and
a separation member that reduces interference between the first sample flow and the atmospheric pressure chemical ionization source assembly and between the second sample flow and the electrospray ion source assembly.

26. The apparatus of claim 25 wherein the separation member includes a metal plate.

27. The apparatus of claim 25 wherein the separation member includes a plate having a cutout portion.

28. The apparatus of claim 25 wherein the separation member includes first and second separator shields spaced apart from each other.

29. The apparatus of claim 28 wherein the separation member includes a layer of electrically insulative material between the first and second separator shields.

30. The apparatus of claim 25, further comprising a mass analyzer configured to receive the first sample flow and the second sample flow.

31. The apparatus of claim 25 wherein the separation member extends at least partially between the electrospray ion source assembly and the atmospheric pressure chemical ionization source assembly.

32. An apparatus for producing ions from chemical species, comprising:
a first ion source assembly that produces a first sample flow;
a second ion source assembly that produces a second sample flow,
wherein the second ion source assembly is different from the first ion source assembly; and
a means for temporarily separating the first sample flow and the second sample flow to reduce interference between the first sample flow and the second ion source assembly and between the second sample flow and the first ion source assembly.

33. The apparatus of claim 32 wherein the means for temporarily separating the first sample flow and the second sample flow extends at least partially between the first ion source assembly and the second ion source assembly.

34. The apparatus of claim 32 wherein the means for temporarily separating the first sample flow and the second sample flow includes a metal plate.

35. The apparatus of claim 32 wherein the means for temporarily separating the first sample flow and the second sample flow includes a plate having a cutout portion.

36. A method for analyzing chemical species, comprising:
producing a first plurality of ions of the chemical species in a first sample flow from a first ion source assembly;
directing the first sample flow toward an inlet of a mass analyzer; producing a second plurality of ions of the chemical species in a second sample flow from a second ion source assembly, the first ion source assembly being different from the second ion source assembly;
directing the second sample flow toward the inlet of the mass analyzer; and
reducing interference between the first ion source assembly and the second sample flow and between the second ion source assembly and the first sample flow with the separation member positioned at least partially between the first and second ion source assemblies.

37. The method of claim 36, further comprising splitting a primary flow of the chemical species into first and second flow portions, introducing the first flow portion into the first ion source assembly and introducing the second flow portion into the second ion source assembly.

38. The method of claim 36, further comprising substantially simultaneously directing the first sample flow and the second sample flow toward the inlet of the mass analyzer.

39. The method of claim 36 wherein producing the first plurality of ions from a first ion source assembly includes providing the first plurality of ions from an electrospray ion source assembly and producing the second plurality of ions from a second ion source assembly includes providing the second plurality of ions from an atmospheric pressure chemical ionization source assembly.

40. The method of claim 36 wherein reducing interference includes reducing interference between the first ion source assembly and the second sample flow and between the second ion source assembly and the first sample flow with a metal plate positioned at least partially between the first ion source assembly and the second ion source assembly.

41. A method for analyzing chemical species, comprising:
providing a first ion source assembly, a second ion source assembly different from the first ion source assembly, a separation member, and a mass analyzer;
simultaneously producing a first plurality of ions in a first sample flow from the first ion source assembly and a second plurality of ions in a second sample flow from the second ion source assembly;
directing the first and second sample flows toward an inlet of the mass analyzer; and
temporarily separating the first sample flow and the second sample flow with the separation member before the first and second sample flows enter the inlet.

42. The method of claim 41, further comprising introducing a first portion of a primary sample flow into the first ion source assembly and a second portion of the primary sample flow into the second ion source assembly.

43. The method of claim 41 wherein providing a first ion source assembly and a second ion source assembly different from the first ion source assembly includes providing an electrospray ion source assembly and an atmospheric pressure chemical ionization source assembly.

44. The method of claim 41 wherein temporarily separating the first sample flow and the second sample flow includes separating the first sample flow and the second sample flow with a metal plate positioned at least partially between the first ion source assembly and the second ion source assembly.

45. The method of claim 41 wherein the separation member includes first and second separator shields spaced apart from each other, and further comprising maintaining the first and second separator shields at selected electrical potentials.

46. The method of claim 45 wherein maintaining the first and second separator shields includes maintaining the first and second separator shields at different electrical potentials relative to each other.

47. A method of manufacturing an apparatus for analyzing chemical species, comprising:
positioning an electrospray ion source assembly proximate to a mass analyzer;
positioning an atmospheric pressure chemical ionization source assembly proximate to the mass analyzer; and
placing a separation member proximate to the mass analyzer, the separation member extending at least partially between the electrospray ion source assembly and the atmospheric pressure chemical ionization source assembly, the separation member configured to temporarily separate a first flow from the electrospray ion source assembly and a second flow from the atmospheric pressure chemical ionization source assembly before the first and second flows enter the mass analyzer.

48. The method of claim 47 wherein placing a separation member includes positioning a metal plate with a cutout portion at least partially between the electrospray ion source assembly and the atmospheric pressure chemical ionization source assembly.
